(19) United States
(12) Patent Application Publication
(10) Pub. No.: US 2014/0191718 A1
(43) Pub. Date: Jul. 10, 2014

(54) SECURE AUTHENTICATION FOR FUELING OF VEHICLES

(71) Applicants: Stacey Reineccius, San Francisco, CA (US); Franklin Gobar, San Rafael, CA (US); John C. Sellers, El Cerrito, CA (US)

(72) Inventors: Stacey Reineccius, San Francisco, CA (US); Franklin Gobar, San Rafael, CA (US); John C. Sellers, El Cerrito, CA (US)

(21) Appl. No.: 14/149,018

(22) Filed: Jan. 7, 2014

Related U.S. Application Data
(63) Continuation-in-part of application No. 13/827,753, filed on Mar. 14, 2013.
(60) Provisional application No. 61/750,631, filed on Jan. 9, 2013.
(60) Provisional application No. 61/750,631, filed on Jan. 9, 2013.

(51) Int. Cl. B60L 11/18

(52) U.S. Cl. CPC B60L 11/1846; B60L 11/182
USPC 320/108; 320/109

(57) ABSTRACT

Systems, methods, and devices for refueling a vehicle are discussed herein. According to one embodiment, a vehicle charging station includes a power distribution interface, a receiver component, and an authorization component. The power distribution interface is configured to electrically couple with and provide electrical power to a power receiving interface of a vehicle. The power distribution interface includes a power cable extending from the vehicle charging station and the power cable includes an outlet plug. The receiver component is configured to receive identification information that uniquely identifies the vehicle from an identification component of the vehicle. The receiver component is configured to communicate with the identification component to allow electrical communication between the identification component and the receiver component when the power receiving interface is electrically coupled to the power distribution interface. The authorization component is configured to allow flow of electrical power to the vehicle in response to authorization based on the received identification information.

### RELATED APPLICATIONS

This application claims the benefit under 35 U.S.C. §119(e) of U.S. Provisional Patent Application No. 61/750,631 filed on Jan. 9, 2013 entitled “Automatic Authentication for Service Access for Fueling of Vehicles” and to U.S. patent application Ser. No. 13/827,753 filed on Mar. 14, 2013 entitled “Automatic Authentication for Service Access for Fueling of Vehicles,” both of which are hereby incorporated herein by reference in their entirety.

### TECHNICAL FIELD

The present disclosure relates to vehicle refueling and more particularly relates to vehicle identification for refueling.

### BRIEF DESCRIPTION OF THE DRAWINGS

FIG. 1 is a schematic diagram illustrating a fuel distribution system consistent with embodiments disclosed herein.

FIG. 2 is a schematic diagram illustrating a fuel distribution station consistent with embodiments disclosed herein.

FIG. 3 is a schematic diagram illustrating a vehicle fueling interface consistent with embodiments disclosed herein.

FIG. 4A is an exploded view of an outlet plug of a fuel distribution station consistent with the embodiments disclosed herein.

FIG. 4B is an assembled view of the outlet plug of FIG. 4A consistent with the embodiments disclosed herein.

FIG. 4C is a front view of an outlet plug tip with notches consistent with embodiments disclosed herein.

FIG. 4D is a perspective view of an outlet plug tip with notches consistent with embodiments disclosed herein.

FIG. 5A is a schematic block diagram illustrating electrical interconnection between portions of a fuel distribution station consistent with embodiments disclosed herein.

FIG. 5B is another schematic block diagram illustrating electrical interconnection between portions of a fuel distribution station consistent with embodiments disclosed herein.

FIG. 6A is a perspective view of a vehicle inlet consistent with embodiments disclosed herein.

FIG. 6B is another perspective view of a vehicle inlet consistent with embodiments disclosed herein.

FIG. 7A is an exploded perspective view of a bezel consistent with embodiments disclosed herein.

FIG. 7B is another exploded perspective view of a bezel consistent with embodiments disclosed herein.

FIG. 8 is a perspective view of a bezel assembly and an applicator consistent with embodiments disclosed herein.

FIG. 9 is a perspective view of an applicator applying a bezel assembly to a vehicle inlet consistent with embodiments disclosed herein.

FIG. 10 is a perspective view of a vehicle and fuel distribution station during refueling consistent with embodiments disclosed herein.

FIG. 11 is a schematic flow chart diagram illustrating a method for providing a refueling subscription consistent with embodiments disclosed herein.

### DETAILED DESCRIPTION OF PREFERRED EMBODIMENTS

Vehicle refueling systems generally operate in an unprotected mode or a protected mode. In unprotected modes, or promiscuous modes, anyone with physical access to the refueling system is allowed to refuel without authentication or payment. In a protected mode, users are generally required to authenticate or pay in some manner before being allowed to refuel a vehicle. Generally, payment or authentication is performed using a card, such as a payment card or authentication card, that can be read by a reader of the refueling system. Example payment cards include credit cards, debit cards, or the like. Example authentication cards include any type of employee card, membership card, or even payment card that may be used to authorize refueling. Generally, payment cards and authentication cards are in a form similar to a credit card, key ring mounted card, or the like. These authentication and identification cards are generally read using a card reader, such as a magnetic card reader, an RFID card reader, or other type of contact or proximity reader.

However, these methods for refueling have a number of significant limitations and disadvantages. First, the above methods make it difficult or impossible to identify the specific vehicle that is being refueled. Because the authentication or payment cards can be passed from one person to the next, the cards may be shared and the same card may be used to fuel multiple vehicles. This loaning potential makes it impossible to be reasonably certain that a specific vehicle is being fueled or that fueling privileges are being used correctly. This allows for potential theft of service and prevents certainty in knowledge of costs and, as such, presents limits on potential service offerings attractive to customers.

Second, the above methods require significant physical and communication infrastructure. For example, credit card readers, display screens, high speed communication connections, and the like are required in order to process payments and/or authenticate an individual or card. Both the physical infrastructure and communication subscriptions add to the cost of refueling for the customer.

Third, a significant amount of manual interaction with an authentication device is required each time a vehicle is refueled. For example, a user may need to swipe a card, enter a personal identification number, and wait for a remote server to authorize fueling, all before any refueling can begin to take place. Furthermore, the cards must be carried by the user, and loss of the authorization card presents inconvenience, and likely, loss of service to the customer.

Fourth, payment and authorization with a remote server must be performed for each refueling occurrence. This results in higher communication demands and also introduces the potential for credit card transaction fees and bank fees with every refueling transaction. Furthermore, no revenue can be recognized from the station unless a transaction is completed under generally accepted accounting principles (GAAP). This makes it impossible to provide a certainty of revenue recognition timing, further complicating accounting and raising per transaction costs.

The above discussed limitations result in significant limits upon the types of subscriptions and services that can be provided to customers. For example, customers are required to pay, based on either the unit of time or the unit of fuel delivered upon each refueling occurrence. Because either the unit time or unit energy delivered must be tracked for each transaction, tracking costs must be taken into account and charged to the customer. Similarly, costs for customer support and revenue recognition must also be accounted for. In some cases, the costs of tracking, customer support and revenue recognition can add significant costs and can even be equal to or greater than the cost of fuel provided. For example, the overhead costs for a fuel distribution station to operate can match or be even greater than the cost of the fuel that is provided.

Based on the foregoing, applicants have recognized that a need exists for simpler and faster identification, as well as for secure identification and authentication for a specific vehicle. Applicants have recognized that, by identifying a specific vehicle, certainty as to identity and fueling requirements can be obtained, convenience can be improved for the customer, and complexity of billing management can be reduced, along with the associated costs for such fuel service delivery. Additionally, identifying a specific vehicle allows for subscription-based refueling where the specific vehicle may be refueled an unlimited amount within a specific subscription period.

As used herein, the terms refueling, fueling, and the like are given to encompass any form of replenishing fuel, an electric charge, or any other energy source for a vehicle or other energy consumption device. For example, the terms refueling and fueling are given to encompass providing a liquid fuel, a gaseous fuel, or even recharging batteries. Similarly, as used herein, the term fuel is given to mean any energy in whatever form consumed by a vehicle or energy consumption device. For example, the term fuel, as used herein, is given to encompass any liquid or gaseous fuels, such as gasoline or hydrogen. The term fuel is also given to encompass other forms of energy such as electricity, electrical charge, and the like.

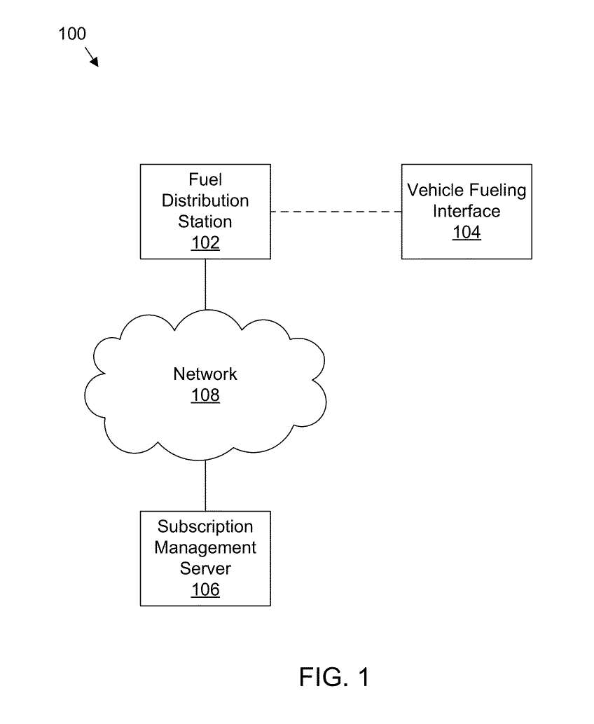

Turning to the figures, FIG. 1 is a schematic diagram illustrating a fuel distribution system 100. The fuel distribution system 100 includes a fuel distribution station 102, a vehicle fueling interface 104, and a subscription management server 106. The subscription management server 106 and the fuel distribution station 102 are shown in communication over a network 108. The vehicle recharging system 100 may be configured to refuel a vehicle or other refuelable or rechargeable device.

The fuel distribution station 102 may include any type of refueling station. For example, the fuel distribution station 102 may include a gas station with one or more pumps and/or may include a recharging station with one or more outlet plugs. For example, the fuel distribution station 102 may represent each fuel pump at a gas station or recharging station. Alternatively, a single fuel distribution station 102 may have multiple outlets or pumps. The fuel distribution station 102 may be configured to uniquely identify a vehicle and determine whether the vehicle is authorized for refueling. According to one embodiment, the fuel distribution station 102 is located at a fixed site where vehicles may arrive to be refueled.

According to one embodiment, the fuel distribution station 102 maintains identification information that corresponds to vehicles with active subscriptions. For example, the fuel distribution station 102 may maintain a list of identification information corresponding to vehicles which should be allowed to refuel at the fuel distribution station 102. The fuel distribution station 102 may allow any vehicle that has an active subscription to refuel at the fuel distribution station 102. Maintaining the identification information at the fuel distribution station 102 may significantly reduce communication costs because the subscription management server 106 may not be required to authenticate each refueling transaction with a remote device or server. For example, a list of active subscriptions may be maintained and compared with identification information to determine if the vehicle can be refueled without accessing a remote server or computer to authorize refueling.

The vehicle fueling interface 104 is configured to receive gas, electricity, or other fuel to refuel a vehicle. In one embodiment, the vehicle fueling interface 104 may include a fuel inlet, such as tubing, to receive a liquid fuel. In another embodiment, the vehicle fueling interface 104 includes an electrical inlet that includes conductors to receive electrical energy. The vehicle fueling interface 104 may be mounted on or in a body of a vehicle. For example, an electrical inlet may be integrated into a body of an electric powered vehicle and a fuel inlet may be integrated into a body of a gas powered vehicle. In one embodiment, the vehicle fueling interface 104 is permanently affixed to the vehicle such that it cannot be moved to another vehicle, or may only be moved with a key or specialized tool and/or damage to the vehicle and/or vehicle fueling interface 104.

The fuel distribution station 102 and the vehicle fueling interface 104 are connected by a dotted line to indicate that they may be configured to be selectively coupled. For example, the fuel distribution station 102 may be located at a fixed location where a vehicle that includes the vehicle fueling interface 104 may be periodically brought for refueling. In one embodiment, the fuel distribution station 102 includes an electrical outlet plug, while the vehicle fueling interface 104 includes an electrical vehicle inlet. In another embodiment, the fuel distribution station 102 includes a fuel pump handle for gasoline or other liquid fuel, while the vehicle fueling interface 104 includes a liquid fuel inlet into the vehicle. Some embodiments may include connectors configured to refuel using a gaseous fuel, such as hydrogen.

The subscription management server 106 may be a computing device that periodically provides updates to the identification information maintained by the fuel distribution station 102. For example, the subscription management server 106 may maintain a list of identification information for vehicles that have active subscriptions. The subscription management server 106 may periodically update this list, or download changes to the list to fuel distribution station 102. In one embodiment, the subscription management server 106 does not provide updates in a real-time manner. For example, the subscription management server 106 may periodically provide updates based on all the changes that have occurred within an update period. The update period may include one hour, multiple hours, one day, one week, one month, or the like. The infrequent updates may result in significant savings in communication costs. In one embodiment, the per transaction costs can be reduced to one list update per update period or less, which may potentially save a significant amount.

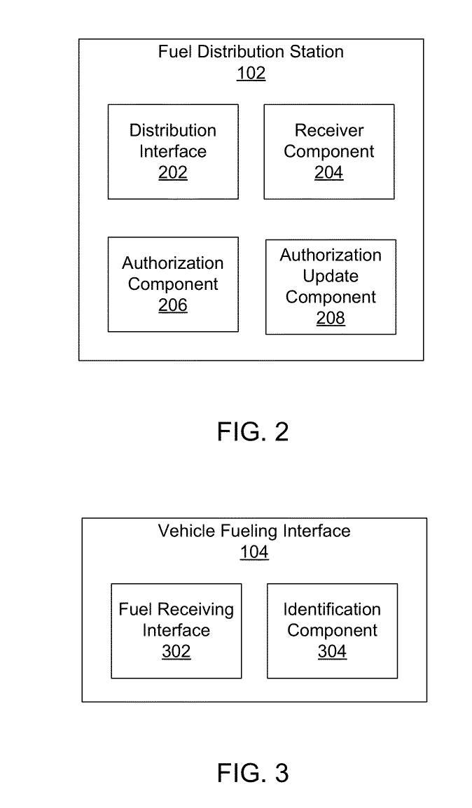

FIG. 2 is a schematic block diagram illustrating components of the fuel distribution station 102. The fuel distribution station 102 includes a distribution interface 202, a receiver component 204, an authorization component 206, and an authorization update component 208. The components 202, 204, 206, and 208 of the fuel distribution station 102 are given by way of example only. One or more of the components 202, 204, 206, and 208 may be omitted and/or additional components may be included, depending on the embodiment.

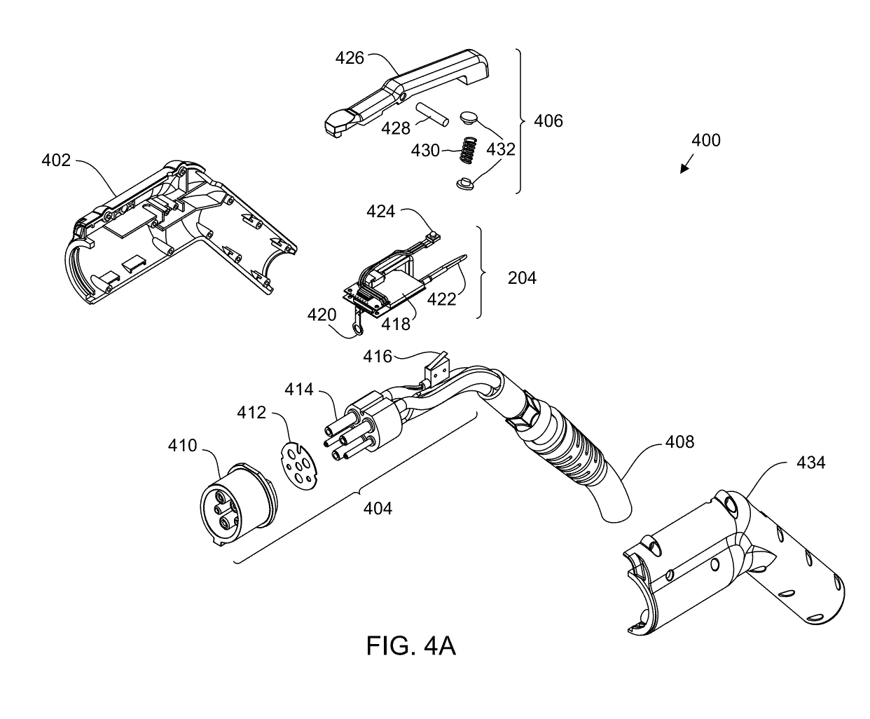

The distribution interface 202 is an interface configured to provide fuel to a vehicle. The distribution interface 202 may be configured to couple with a fuel receiving interface of a vehicle, such as the fuel receiving interface 302 discussed in relation to the vehicle fueling interface 104 of FIG. 3.

In one embodiment, the distribution interface 202 is configured to provide a liquid fuel to a vehicle. For example, the distribution interface 202 may include tubing from a body of a gas pump and through a gas pump handle through which gasoline is provided to a vehicle. The fuel distribution station 102 may pump fuel through the distribution interface 202 to fill up a gas tank or other storage system of the vehicle.

In another embodiment, the distribution interface 202 is configured to provide electrical energy to a vehicle. For example, the distribution interface 202 may include a power distribution interface for electrically coupling with and providing electrical power to a power receiving interface of a vehicle, such as the fuel receiving interface 302 discussed in relation to the vehicle fueling interface 104 of FIG. 3. In one embodiment, the power distribution interface includes a power cable extending from the fuel distribution station 102. The power distribution interface may include an outlet plug on the end of the power cable through which electrical energy may be passed to a vehicle. In one embodiment, the outlet plug, power cable, and other aspects of the distribution interface 102 and/or fuel distribution station 102 comply with a vehicle recharging standard. Examples of vehicle recharging standards include the society of automotive engineers (SAE) J1772 standard, the CHadeMO Association's “Charge de Move” (CHAdeMO) standard, a Tesla® standard, SAE Combo 2 standard, or the like. In some embodiments, outlet plugs or interfaces that comply with other recharging standards, derivatives of these standards, or proprietary interfaces may be used.

In one embodiment, the distribution interface 202 may not need to physically contact a vehicle or fuel receiving interface 302 of a vehicle to provide electrical power. For example, the distribution interface 202 may include a wireless power coupling that is configured to electrically couple wirelessly with a wireless power coupling of a vehicle. The wireless power couplings of the distribution interface 202 and the vehicle may include coils of wire with corresponding sizes. One of skill in the art will recognize considerable variation for wireless power couplings and/or proximity charging that may be used for refueling an electric vehicle.

In one embodiment, the distribution interface 202 and/or fuel distribution station 102 may include an indicator light to indicate a refueling status for a vehicle. For example, a single or multicolor indicator light may be controlled according to multiple states to indicate whether a distribution interface 202 is connected with a vehicle, indicate whether a vehicle is authorized for refueling, indicate progress in the refueling process, and/or indicate whether refueling is complete.

The receiver component 204 is configured to receive identification information from a vehicle. The receiver component 204 may receive identification information that uniquely identifies a vehicle. In one embodiment, the receiver component 204 includes a tag reader that reads information from a tag mounted on the vehicle. For example, the receiver component 204 may include an RFID tag reader that may be used to read RFID tags on the vehicle. In one embodiment, each RFID tag on a vehicle includes unique identification information which may be used by the fuel distribution station 102 to identify the vehicle. In one embodiment, the receiver component 204 may query and/or receive identification information from tags or chips which communicate over a wired interface. For example, the receiver component 204 may include a tag reader configured to receive the identification information from a tag over a wired connection.

The receiver component 204 may be positioned to align with an identification component of a vehicle when the distribution interface 202 is connected with a fuel receiving interface 302. For example, the receiver component 204 may be positioned such that it may receive identification information from the vehicle when the fuel receiving interface of a vehicle fueling interface 104 is coupled to the distribution interface 202. In one embodiment, the receiver component 204 includes an antenna in the distribution interface 202 that aligns with an RFID tag or other identification component of a vehicle when the fuel distribution station 102 and a vehicle fueling interface 104 are coupled for fueling. In one embodiment, the receiver component 204 may be located within a portion of the distribution interface 202, such as within an outlet plug, power cable, fuel pump handle, or other location of the fuel distribution station 102. In one embodiment, the receiver component 204 includes an RFID tag reader in an outlet plug of the distribution interface 202 and the RFID tag reader includes an antenna to activate and/or receive data from an RFID tag.

The receiver component 204 may be in electrical communication with one or more conductors which electrically couple with a fuel receiving interface. For example, the receiver component 204 may contact a conductor which is in electrical communication with a tag or chip that is configured to relay identification information to the receiver component 204. For example, various recharging standards include a plurality of conductors to provide a ground line, proximity line, power providing lines, communication lines, or the like. In one embodiment, the receiver component 204 may electrically connect to a conductor used in a recharging standard and receive the identification information via the conductor. For example, a proximity line, ground, line, or other line may be used for the function indicated by the recharging standard as well as to provide/receive identification information corresponding to a vehicle. An identification component 304 may be similarly electrically connected to the corresponding line or conductor or may be configured to connect to the corresponding line or conductor when the distribution interface 202 is coupled to a vehicle fueling interface 104.

In one embodiment, the receiver component 204 may receive the identification information in response to coupling of the distribution interface 202 and the fuel receiving interface. For example, the receiver component 204 may be configured to query and/or receive the identification information in response to the distribution interface 202 being coupled to a vehicle fueling interface 104. In one embodiment, the receiver component 204 includes an RFID tag reader that reads a passive, active, or battery assisted passive RFID tag. In one embodiment, the receiver component 204 includes a tag reader or other device that reads data transmitted over a wired connection with an identification component 304. In one embodiment, the tag reader provides a valid passcode to the tag or chip before the tag or chip will provide the identification information. In one embodiment, the receiver component 204 includes a transceiver to communicate with a tag, chip, or other device that provides identification data over a wired and/or wireless connection.

In one embodiment, the tag or other chip or device of the identification component 304 can store a unique security code that is changed by a signal from the vehicle fueling interface 104 after each fueling session and then sent by the fuel distribution station 102 and/or to the subscription management server 106 during the next regular periodic update for dissemination to other vehicle fueling stations. This security code can protect against a duplication of the tag and assures that a single vehicle ID can only be used in a single fueling session.

The authorization component 206 is configured to allow refueling of a vehicle based on identification information received by the receiver component 204. For example, the receiver component 204 may receive identification information and the authorization component 206 may determine whether the received identification information is valid and/or corresponds to an active account or subscription. In one embodiment, the authorization component 206 compares the identification information to a list of authorized identification information. For example, if the identification information corresponds to an entry in the list, the authorization component 206 may determine that the vehicle is authorized for refueling. The list may be maintained locally at the fuel distribution station 102 or a site of the fuel distribution station 102 such that no connection to the Internet or other large network is required to authorize refueling. If the identification is valid and/or corresponds to an active account or subscription, the authorization component 206 may authorize the refueling of the vehicle. For example, the authorization component 206 may allow electrical power, gasoline, hydrogen, or any other type of fuel to flow to the vehicle.

In one embodiment, the fuel distribution station 102 may include a flow component (not shown) for selectively allowing flow of fuel to a vehicle. For example, the flow component may include an electrical switch, a pump, or other devices that can be used to selectively allow, cause, or block flow of a fuel to the vehicle. In one embodiment, the flow component may be controlled by the authorization component 206. For example, the authorization component 206 may place the flow component in a state that allows flow when a vehicle is authorized and may place the flow component in a state that does not allow flow when a vehicle is not authorized or the distribution interface 202 is not connected to a vehicle.

The authorization update component 208 may periodically update information that indicates which vehicles are authorized for refueling. For example, the authorization update component 208 may periodically receive information from a subscription management server 106 to update a list of identification information that correspond to vehicles which should be allowed to refuel. In one embodiment, the authorization update component 208 is configured to check for updates every minute or more, every hour or more, every day or more, or on some other time period. According to one embodiment, infrequent updates may decrease costs for a communication connection and thereby reduce fueling costs or subscription costs to customers. On the other hand, more frequent updates may allow for a fuel distribution station 102 to reflect a more current status for all vehicles that are allowed to be recharged.

FIG. 3 is a schematic block diagram illustrating components of the vehicle fueling interface 104. The vehicle fueling interface 104 includes a fuel receiving interface 302 and an identification component 304. Additional, fewer, or alternate components may be included in some embodiments.

The fuel receiving interface 302 is configured to receive fuel from the fuel distribution station 102. The fuel receiving interface 302 may be configured to couple with a distribution interface of a fuel distribution station 102, such as the distribution interface 202 discussed above in relation to the fuel receiving interface 302 of FIG. 2. In one embodiment, the fuel receiving interface 302 is configured to receive liquid or gaseous fuel and direct it to a storage system of the vehicle. For example, the fuel receiving interface 302 may include a fuel inlet for a liquid or gaseous fuel and tubing from the inlet to a gas tank.

In another embodiment, the fuel receiving interface 302 includes a power receiving interface configured to electrically couple with and receive electrical power from the distribution interface 202. In one embodiment, the fuel receiving interface 302 includes a vehicle inlet that includes a conductor configured to physically mate with an outlet plug of the distribution interface 202. For example, the fuel receiving interface 302 may include a female inlet that includes conductors for contacting male outlet conductors of the distribution interface 202. In some embodiments, the vehicle inlet may include male connectors and the distribution interface 202 may include female connectors. The electrical power may be used to recharge batteries, a fuel cell, capacitors, or other power storage system of a vehicle. The fuel receiving interface 302 may include an electrical inlet which may be used to receive electrical energy and pass it to a power storage system of the vehicle. In one embodiment, the vehicle inlet, power storage system, and other aspects of the vehicle fueling interface 104 and/or vehicle may comply with a vehicle recharging standard. Examples of vehicle recharging standards include the society of automotive engineers (SAE) J1772 standard, the CHAdeMO standard, or the like. In some embodiments, vehicle inlets that comply with other recharging standards or derivatives of these standards, without limitation, may be used.

In one embodiment, the fuel receiving interface 302 and distribution interface 202 may not need to make physical contact to electrically recharge a vehicle. For example, the fuel receiving interface 302 may include a wireless power coupling that is configured to electrically couple wirelessly with a wireless power coupling of the fuel distribution station 102. The wireless power couplings of the fuel receiving interface 302 and the fuel distribution station 102 may include coils of wire with corresponding sizes. One of skill in the art will recognize considerable variation for wireless power couplings and/or proximity charging that may be used for refueling an electric vehicle.

The fuel receiving interface 302 and/or the vehicle fueling interface 104 may be integrated within a body of a vehicle. For example, the fuel receiving interface may include tubing, wiring, and/or other portions that are integrated with a body of the vehicle. The fuel receiving interface 302 may be difficult or impossible to remove without damaging the fuel receiving interface 302 or the vehicle. According to one embodiment, a fuel receiving interface 302 that is integrated within a body of a vehicle is more difficult to remove or alter than a cable extending from the vehicle, or the like. For example, cables may be spliced, swapped, or modified more freely than an inlet mounted within the body of a vehicle.

The identification component 304 provides identification information to a fuel distribution station 102. The identification information may uniquely identify a vehicle on which it is mounted. For example, the identification information may include a unique identification number, an account number, or any other information that may be used to uniquely identify a vehicle.

The identification component 304 may be positioned to align with a receiver component 204 of the fuel distribution station 102 when the fuel receiving interface 302 is coupled to the distribution interface 202. The alignment of the identification component 304 with the receiver component 204 may allow electrical or electromagnetic communication between the identification component 304 and the receiver component 204. For example, the identification component 304 may include a passive, active, or battery assisted passive RFID tag that stores identification information. The RFID tag may be mounted on a vehicle inlet, such that an RFID tag reader in the outlet plug aligns with the RFID tag when the inlet and outlet plug are coupled.

In one embodiment, the identification component 304 may be electrically coupled to a conductor that is configured to make contact with an electrical conductor of the distribution interface 202. For example, the identification component 304 may be coupled to a spring loaded conductor that contacts a conductor of the distribution interface 202 or fuel receiving interface 302 to provide a communication pathway to provide the identification information to the receiver component 204. In one embodiment, conductors of the distribution interface 202 or fuel receiving interface 302 that are already used for purposes prescribed by a recharging standard may also be used to provide a communication pathway between an identification component 304 and receiver component 204.

The identification component 304 may provide the identification information in response to a query from the receiver component 204. In one embodiment, the identification component 304 may require a valid passcode from the fuel distribution station 102 before providing the identification information.

In one embodiment, the identification component 304 may be permanently affixed to a vehicle. As used herein, the term permanently affixed is given to mean that the identification component 304 is affixed or mounted on a vehicle in a manner that it is not removable in a functional state, requires a specialized key or tool for removal, and/or is only removable with damage to the vehicle. For example, the identification component 304 may not be removable from the vehicle while maintaining the identification component 304 of identification information in a functional state. In one embodiment, the identification component 304 is mounted on a vehicle inlet which is permanently affixed to the vehicle. The identification component 304 may not be removable because of how it is mounted, such as by using a strong and permanent adhesive, embedded in an object, or the like.

In one embodiment, the identification component 304 is not removable from the vehicle without damaging the identification component 304. For example, the identification component 304 may be securely glued, welded, or embedded within the vehicle, body of the vehicle, or portion of the vehicle so that it can only be removed with physical damage to the identification component 304 or the vehicle.

In one embodiment, the identification component 304 self destructs in response to removal from the vehicle. For example, the identification component 304 may be configured to detect removal or attempted removal from the vehicle and the identification component 304 may self destruct. In one embodiment, the identification component 304 self destructs by electronically destroying the identification information. For example, a transitory or non-transitory memory may be erased. In another embodiment, the identification component 304 self destructs by mechanically destroying the identification component 304. For example, if the identification component 304 includes a tag or chip, the tag or chip may be configured to be mechanically destroyed so that it no longer functions and/or that the memory of the tag or chip is damaged or erased.

According to one embodiment, the fuel distribution station 102 and vehicle fueling interface 104 may provide significant benefits with regard to reduced costs and flexibility in ways that fueling services can be billed. In one embodiment, authentication and refueling may happen automatically. For example, because the receiver component 204 and identification component 304 are aligned or are in electrical or electromagnetic communication, the user may only need to insert the distribution interface 202 into the fuel receiving interface 302 to begin and accomplish fueling. No card swipes, number entry, signatures, or network server based authentication may be needed to begin the fueling.

In another embodiment, “sharing” of authorization information or cards is prevented because the identification component cannot be moved to another vehicle and cannot be used to authorize fueling for another vehicle. For example, when the distribution interface 202 and the fuel receiving interface 302 are coupled, the receiver component 204 is blocked from receiving identification information from any other vehicle or device. Similarly, the identification component 304 is also blocked from providing identification information to a different station or interface. If the distribution interface 202 and fuel receiving interface 302 are decoupled, or if the identification component 304 is removed, fueling may be stopped.

According to one embodiment, because sharing is prevented and because a specific car can be identified, a maximum potential cost for a subscription can be calculated. This allows for various subscription based services and payment that would otherwise not be possible. Furthermore, less infrastructure is needed because there may be no need for card readers, display screens, or the like.

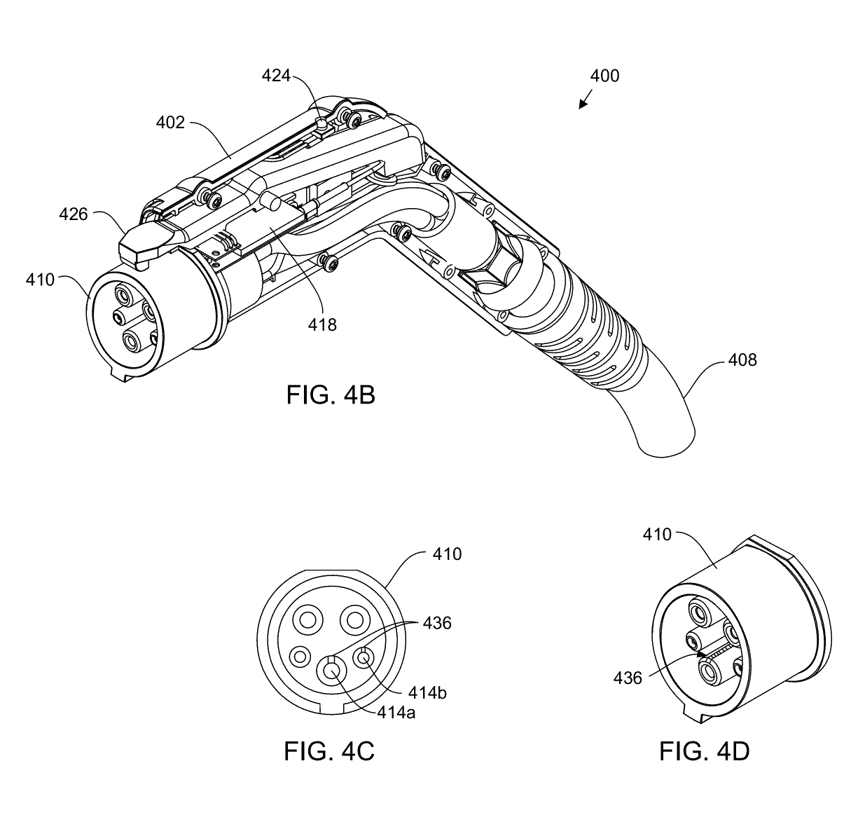

FIGS. 4A and 4B illustrate an outlet plug 400 of a fuel distribution station 102 that complies with an SAE J1772 standard. The outlet plug 400 includes a housing formed by a right handle cover 402 and a left handle cover 434. The outlet plug 400 also includes a power distribution interface 404, a receiver component 204, a latch assembly 406, and may be connected to a body of a fuel distribution station 102 by a power cable 408. FIG. 4A illustrates the outlet plug 400 in an exploded view with various parts of the outlet plug 400 unassembled. FIG. 4B illustrates the outlet plug 400 in an assembled view with the left handle cover 434 omitted for internal viewing of the outlet plug 400. Although the embodiment of FIGS. 4A and 4B illustrates a recharging outlet plug, one of skill in the art will recognize that the scope of the present disclosure encompasses a fuel pump handle or other refueling handle or any other interface for refueling a vehicle.

The power distribution interface 404 includes a plug tip 410, a rubber gasket 412, male conductors 414, and a safety switch 416. In one embodiment, some of the male conductors 414 are used to provide power to recharge a vehicle, while others of the male conductors 414 are used to communicate with a charging system of a vehicle, receive identification information for the vehicle, and/or detect a proximity of a vehicle inlet. The safety switch 416 may be used to break an electrical or communication connection to a vehicle and/or enable an authorization process.

The receiver component 204 includes a receiver board 418 that is connected to an antenna 420 and light emitting diode (LED) 424. The receiver board 418 may include circuitry for querying and/or receiving identification information from a vehicle via the antenna 420. The circuitry of the receiver board 418 may also include circuitry for controlling the LED 424. The LED may include a single color or multi color LED which may be used to indicate an authorization status, charging status, or other status of a connected vehicle or fuel distribution station 102. The receiver component 204 is also connected to one or more communication lines 422 which may be used to communicate with an authorization component 206 or other components of a fuel distribution station 102.

The latch assembly 406 may be used to selectively secure the outlet plug 400 to an inlet of a vehicle. The latch assembly 406 may also be configured to depress the switch 416 each time the latch 426 is pressed and/or each time the outlet plug 400 is coupled or decoupled from a vehicle. The latch assembly 406 includes a latch 426, dowel pin 428, spring 430, and spring mounts 432.

According to one embodiment, in the assembled state as depicted in FIG. 4B, the antenna 420 resides between the male conductors 414. This location may match a location of an identification component 304 of a vehicle inlet.

The outlet plug 400 is given by way of example only. For example, the antenna 420 may be omitted in cases where wireless communication with an identification component 304 is not used. In some embodiments, wired communication between a receiver component 204 and an identification component 304 may be established over a wired connection, wireless connection, or both. If wired communication is used, a receiver component 204 may be located in the outlet plug 400 or may be located in the body of a fuel distribution station 102 or elsewhere. In one embodiment, the outlet plug 400 may be modified from that depicted in FIGS. 4A and 4B in order to provide a wired connection between an identification component 304 and a receiver component 204. In one embodiment, for example, the receiver component 204 may be electrically connected with a conductor 414 and the plug tip 410 may include notches such that a tag, chip, or other identification component 304 can be in electrical contact with one or more of the conductors 414. Thus, wired electrical communication between a receiver component 204 and an identification component 304 may be established via one of the conductors 414 or other conductor.

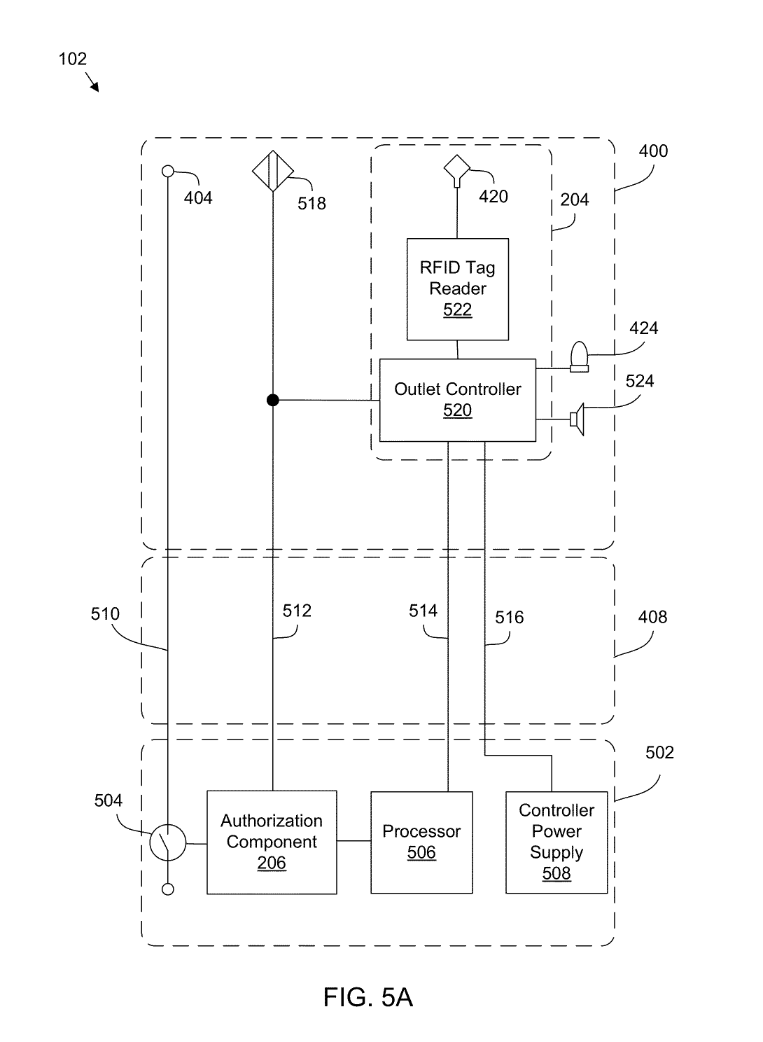

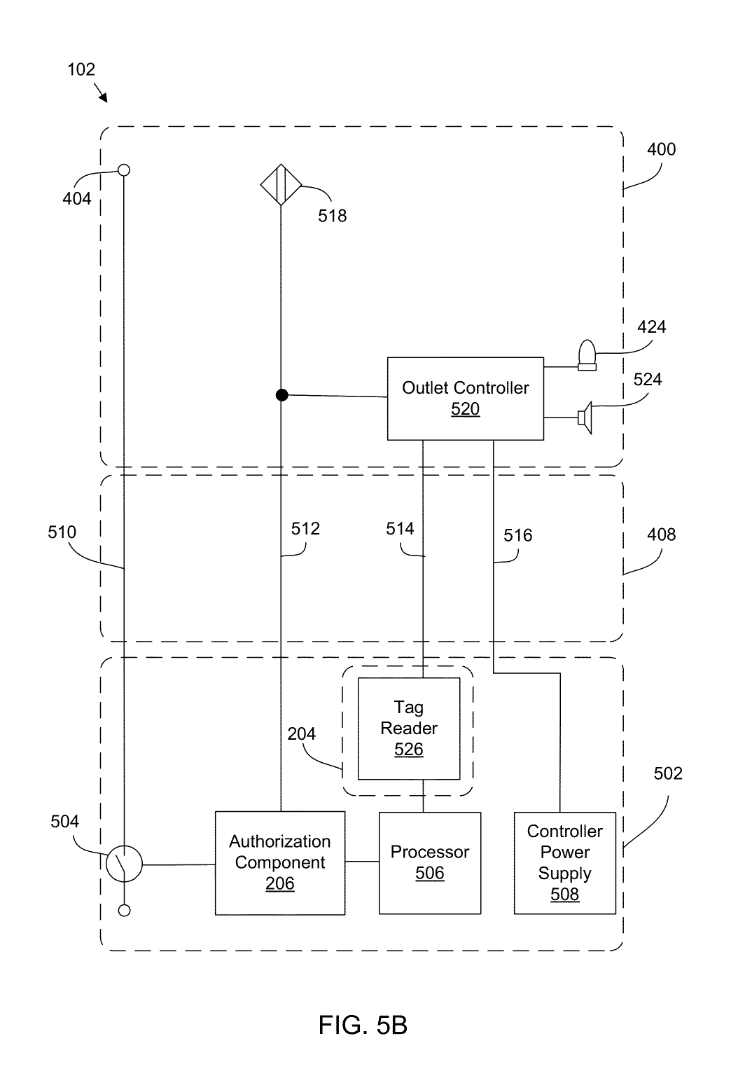

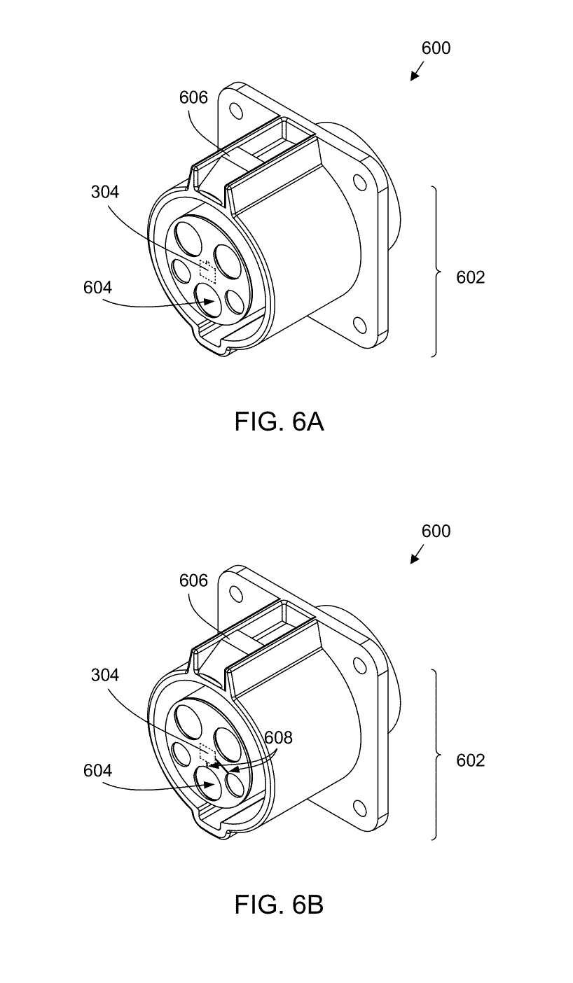

FIGS. 4C and 4D illustrate one embodiment of a plug tip 410 with notches 436 for allowing an identification component 304 mounted in a vehicle inlet (e.g., see FIGS. 6B and 7B) to create an electrical connection to a ground conductor 414a and a proximity conductor 414b. The notches 436 are illustrated facing the interior of the plug tip 410, but may be located in any position needed to create electrical contact with a trace, contact, or spring actuated contact on a fueling interface 104 of a vehicle, adapter, or other contact in communication with an identification component 304 of the fueling interface 104. The notches 436 include gaps in insulation surrounding a conductor 414 so that a contact, trace, or other electrical conductor connected to a chip or tag in a vehicle fueling interface may create physical electrical contact with the proximity conductor 414b and/or the ground conductor 414a. In one embodiment, the notches 414 may be filled with a conductive material to provide conduction through the plug tip. In one embodiment, a spring actuated conductor may be placed within a notch 436 to facilitate contact between the proximity conductor 414b and ground conductor 414a. Further discussion regarding physical conductive communication between the conductors 414 and a tag, chip, or other identification component 304 will be provided in relation to FIGS. 5B, 6B, and 7B.

FIG. 5A is a schematic diagram showing one embodiment of electrical interconnection between portions of a fuel distribution station 102. For example, the electrical interconnection in FIG. 5A may correspond to an embodiment that uses an RFID tag reader or other wireless communication device to receive identification information from a tag, chip, or other identification component of a fueling interface 104 or vehicle. The fuel distribution station 102, as depicted, includes a station housing 502, a power cable 408, and an outlet plug 400. The station housing includes a flow component 504, an authorization component 206, a processor 506, and a controller power supply 508. The power cable 408 includes a power distribution line 510, a proximity detect line 512, a communication line 514, and a power supply line 516. The lines 510, 512, 514, and 516 may include more than one conductive line. For example, the communication line 514 may include two or more wires for communication between components, and the power supply line 516 may include a two or more conductors to provide electrical energy. In one embodiment, the power distribution line 510 may be replaced by a carrier tube for a liquid or gaseous fuel. The outlet plug 400 includes a power distribution interface 404, a proximity detector 518, and a receiver component 204. The receiver component 204 includes an outlet controller 520, an RFID tag reader 522, and an antenna 420. The receiver component 204 is also connected to an LED 424 and speaker 524.

The authorization component 206 receives input from the proximity detector 518 via the proximity line 512 and from the processor 506. The authorization component 206 controls a flow component 504 that includes a switch for selectively allowing flow of electricity to the power distribution interface 404. The processor 506 receives identification information from the receiver component 502 via the communication line 514 and may process and/or provide that identification information to the authorization component 206. The controller power supply 508 provides power to the receiver component 204 via the power supply line 516.

The outlet controller 520 receives an indication of proximity from the proximity detector 518 and identification information via the antenna 420 and RFID tag reader 522. The outlet controller 520 may provide data to and/or receive data from the processor 506. For example, the authorization component 206 may determine whether a vehicle is authorized and provide an indication of authorization or rejection via the processor 506 and communication line 514. The communication line 514 may include any type of communication line that includes one or multiple conductors or lines. For example, a coaxial cable, twisted pair cable, or other cables may be used.

The outlet controller 520 may control a state and/or color of the LED 424. In one embodiment, the outlet controller 520 turns the LED 424 off when the fuel distribution station 502 does not sense a connected vehicle. The outlet controller 520 may turn the LED 424 on in a solid green when a vehicle is being recharged. If a vehicle is connected but no identification information was received, the outlet controller 520 may cause the LED 424 to blink red. If a vehicle is connected and identification information is detected but not valid, the outlet controller 520 may cause the LED 424 to alternately blink red and then blink green. If the vehicle is disconnected, the outlet controller 520 may turn off the LED 424.

The outlet controller 520 may play sounds via the speaker 524 that indicate a charging status, authorization status, a warning, or other information regarding the fuel distribution station 102 or an attached vehicle.

FIG. 5B is a schematic diagram showing another embodiment of an electrical interconnection between portions of a fuel distribution station 102. For example, the electrical interconnection in FIG. 5B may correspond to an embodiment that uses a tag reader 526 or other communication device to receive identification information from a tag, chip, or other identification component over a wired connection. The fuel distribution station 102, as depicted, includes a station housing 502, a power cable 408, and an outlet plug 400. The station housing includes a flow component 504, an authorization component 206, a processor 506, a controller power supply 508, and a receiver component 204. The receiver component 204 is illustrated in the station housing but may be located elsewhere, such as within the outlet plug 400. The receiver component 205 includes a tag reader 526. The tag reader 526 may be configured to read identification information from a tag, chip, or other identification component over a wired connection. The tag reader may include a 1-Wire™ tag reader manufactured by Maxim® or other similar reader or programmable device. The tag may include a 1-Wire™ tag, such as a 1-Wire® EEPROM, such as the DS28E22 DeepCover Secure Authenticator available through Maxim®.

The power cable 408 includes a power distribution line 510, a proximity detect line 512, a communication line 514, and a power supply line 516. The lines 510, 512, 514, and 516 may each include more than one conductive line. For example, the communication line 514 may include two or more wires for communication between components and the power supply line 516 may include a pair of hot power supply conductors to provide electrical energy (e.g., two or more of conductors 414 of FIG. 4A). In one embodiment, the power distribution line 510 may be replaced by a carrier tube for a liquid or gaseous fuel.

The outlet plug 400 includes a power distribution interface 404, a proximity detector 518, and an outlet controller 520. The proximity detector 518 may include a conductor or sensor that senses a proximity of a vehicle fueling interface 104. For example, the proximity detector may be a capacitive or inductive detector that detects a voltage or current in a nearby vehicle fueling interface 104. In another embodiment, the proximity detector 518 may include an electrical contact that contacts a conductor of the vehicle fueling interface 104 when the outlet plug 400 is coupled to the vehicle fueling interface 104. For example, when a voltage or current is sensed through the proximity detect line 512, this may signal that the outlet plug 400 is coupled to an inlet of the vehicle. The outlet controller 520 is connected to and controls an LED 424 and speaker 524.

The authorization component 206 receives input from the proximity detector 518 via the proximity line 512 and input from the processor 506. The authorization component 206 controls a flow component 504 that includes a switch for selectively allowing flow of electricity to the power distribution interface 404. The processor 506 receives identification information from the receiver component 502 and may process and/or provide that identification information to the authorization component 206. The controller power supply 508 provides power to the receiver component 204 via the power supply line 516.

The tag reader 526 receives identification information from an identification component over the proximity line 512 (e.g. via the authorization component or outlet controller 520). For example, the proximity line may be electrically coupled with an identification component 304, such as a 1-Wire™ chip manufactured by Maxim® or other similar chip or programmable device that stores identification information. The tag reader 526 provides the information to the processor 506 and/or the outlet controller 520. Thus, the fuel distribution station 102 may receive the identification information over a wired connection using the proximity line 512 and/or a ground line.

For example, the authorization component 206 may determine whether a vehicle is authorized and provide an indication of authorization or rejection via the processor 506, tag reader 526, and communication line 514. The communication line 514 may include any type of communication line that includes multiple conductors or lines. For example, a coaxial cable, twisted pair cable, or other cables may be used.

FIG. 6A is a perspective view of a vehicle inlet 600. The vehicle inlet 600 is one embodiment of a fuel receiving interface 302 that includes an identification component 304. The vehicle inlet 600 includes an inlet body 602, female conductors within recesses 604, at least a portion of an identification component 304, and a latch ridge 606.

The inlet body 602 and recesses 604, in the depicted embodiment, are configured to mate with the power distribution interface 404 of FIGS. 4A and 4B. For example, the recesses 604 may be shaped to receive the male conductors 414 to allow female conductors to electrically couple with the male conductors 414. The latch ridge 606 is positioned and shaped to engage the latch 426 to retain the plug outlet 400 to the vehicle inlet 600.

In one embodiment, the identification component 304 includes an RFID tag embedded near a surface of the vehicle inlet 600. When the inlet body 602 and the outlet plug 400 are coupled, the RFID tag is positioned to align with the antenna 420 of FIGS. 4A and 4B. The RFID tag and antenna 420 may then be in electrical communication so that identification information can be passed from the RFID tag to the fuel distribution station 102. In one embodiment, the identification component 304 the vehicle inlet 600 may be configured at manufacture to hold an RFID tag or other identification component 304. In other embodiments, an RFID tag or other identification component 304 may be mounted on the vehicle inlet 600 after manufacture or even upon a vehicle inlet of a vehicle. For example, an aftermarket mounting of an identification component 304 may be performed on any vehicle fueling interface 104. In one embodiment, an identification component 304 configured to communicate over a wired connection may be in electrical communication with female conductors within recesses 604. Thus, wired electrical communication may be established between the identification component 304 and a receiver component 204 connected to one of conductors 304 of FIG. 4A.

FIG. 6B is a perspective view of another embodiment of a vehicle inlet 600. The vehicle inlet 600 may be similar to the vehicle inlet 600 of FIG. 6B but also includes conductors 608 which provide electrical communication between the identification component 304 and a conductor 414 of the outlet plug 400 when the outlet plug 400 is coupled to the vehicle inlet 600. In one embodiment, the conductors 608 may contact a conductor in a notch 436 of the outlet plug 400 to allow a chip, tag, or other identification component 304 configured to communicate over a wired interface to communicate with a receiver component 204 of a distribution station 102. In one embodiment, the conductors 608 may include traces, electrical contacts, and/or spring activated contacts to create an electrical contact with a notch 436 of the outlet plug 400.

FIG. 7A illustrates a bezel assembly 700 for mounting an RFID tag 702 on a vehicle inlet 600. In one embodiment, the bezel assembly 700 may be used to perform an aftermarket mounting of an RFID tag 702 or other identification component 204 on a vehicle with an SAE J1772 compliant vehicle inlet. The bezel assembly 700 includes a tag bezel 704, an adhesive layer 706, and a removable backing 708. The tag bezel 704 is configured to receive the RFID tag 702. The adhesive layer 706 is configured to securely mount the tag bezel 704 and RFID tag 702. In one embodiment, the adhesive layer 706 comprises a pressure sensitive adhesive that is activated when pressure is applied. The removable backing 708 protects the adhesive layer 706 until the bezel assembly 700 is ready for mounting.

In one embodiment, the tag bezel 704 may also include an antenna to allow the RFID tag 702 to communicate with an RFID tag reader. In another embodiment, the RFID tag 702 may be located elsewhere and electrically connected to the antenna positioned proximally to the receiver component 204.

FIG. 7B illustrates a bezel assembly 700 with a tag 710 that is configured to communicate over a wired interface and conductors 608 for providing an electrical connection with conductors 414 of an outlet plug 400 or female conductors in recesses 604 of a vehicle inlet 600.

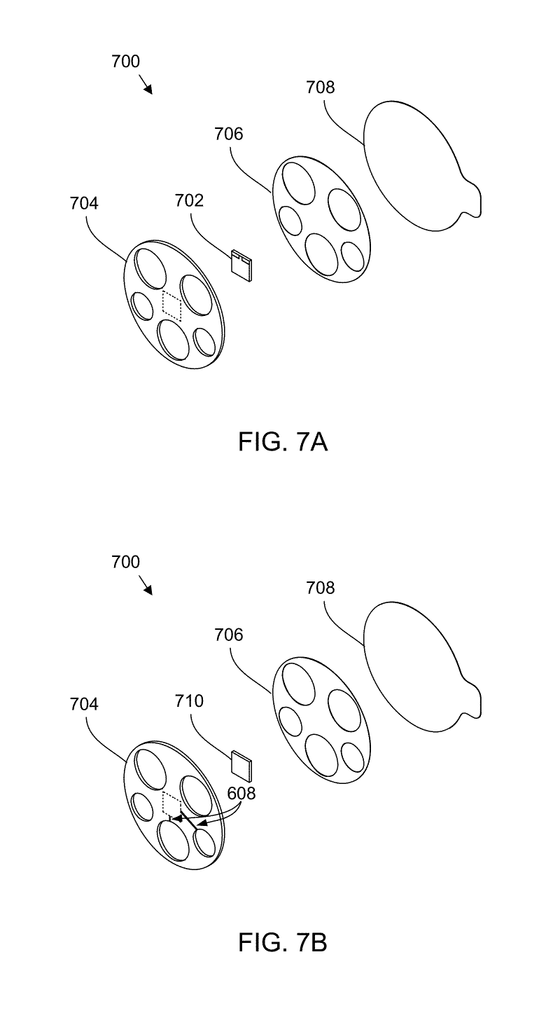

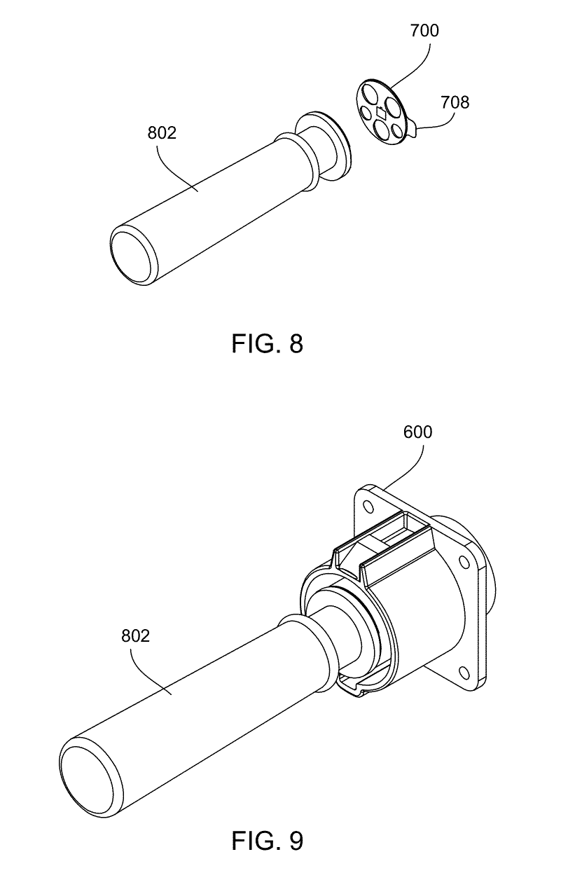

FIGS. 8 and 9 illustrate mounting of the tag bezel assembly 700 on a vehicle inlet 600. In FIG. 8 the bezel assembly 700 (e.g., the bezel assembly 700 of FIG. 7A or 7B) and an applicator 802 are shown. The applicator 802 allows a user to provide pressure to the bezel assembly 700 to secure a tag and bezel assembly to a vehicle inlet. The removable backing 708 is removed before application and the bezel assembly 700 is applied to a vehicle inlet with force. FIG. 9 illustrates the applicator 802 as force is applied to the vehicle inlet 600 to secure the bezel assembly 700 to the vehicle inlet 600.

The applicator 802 may be used to apply a tag bezel assembly 700 with a tag that is configured to communicate wirelessly or over a wired interface. Furthermore, although the applicator 802 is illustrated in conjunction with a J1772 vehicle inlet 600, any type of vehicle inlet is contemplated within the scope of the present disclosure. For example, electrical inlets for different types of vehicles may utilize different standards and have different shapes or configurations. In one embodiment, a tag or tag bezel assembly may be mounted on an interface for a Tesla® vehicle which includes male conductors rather than female receptacles. In one embodiment, a tag for wired communication (such as a 1-Wire™ chip manufactured by Maxim®) may be mounted between a ground conductor and a proximity conductor. The tag may be able to communicate over the proximity conductor and/or ground conductor with a vehicle fueling station to provide identification information to identify the vehicle.

In one embodiment, using a wired connection may provide for more secure and/or more successful communication of identification information from the vehicle to the distribution station 102. For example, because different vehicles may have vehicle inlets complying with different standards, one or more adapters may be needed between the vehicle inlet and the outlet plug 400. If a RFID tag is used, there may be less likelihood that a tag reader can receive identification information from the RFID tag due to the intervening adapters. However, if the identification information is provided over a proximity line, ground line, or other line used to provide power or communication between the distribution station and vehicle, then the adapters will carry this information as well.

In one embodiment, a distribution interface 202 complying to one recharging standard may be used to recharge a vehicle having a fuel receiving interface 302 complying with a different recharging standard. For example, an outlet plug 400 complying with an SAE J1772 standard may be used to recharge a Tesla® vehicle having a proprietary Tesla® vehicle inlet. Because a Tesla® vehicle inlet has a different physical configuration from, but uses the same communication protocol as, the SAE J1772 standard, a physical adapter may be used to couple the Tesla® vehicle inlet to a SAE J1772 outlet plug. Because the adapter may block wireless communication between an RFID tag and an RFID tag reader, wired electrical communication between an identification component 304 on the vehicle with the Tesla® vehicle inlet and a receiver component 204 of a fuel distribution station 102 may be needed. In one embodiment, a chip or tag may be mounted to the Tesla® vehicle inlet and electrical communication between a conductor of the Tesla® vehicle inlet and the chip or tag may be created (e.g., using a wire, trace, or other conductor). A tag reader (or other receiver component 204) of the fuel distribution station 102 may be electrically connected to a conductor or line that corresponds to the conductor to which the chip or tag of the Tesla® vehicle inlet was connected. Thus, even if an adapter is used to couple a distribution interface 202 to a fuel receiving interface 302, communication between a receiver component 204 and an identification component 304 may be established.

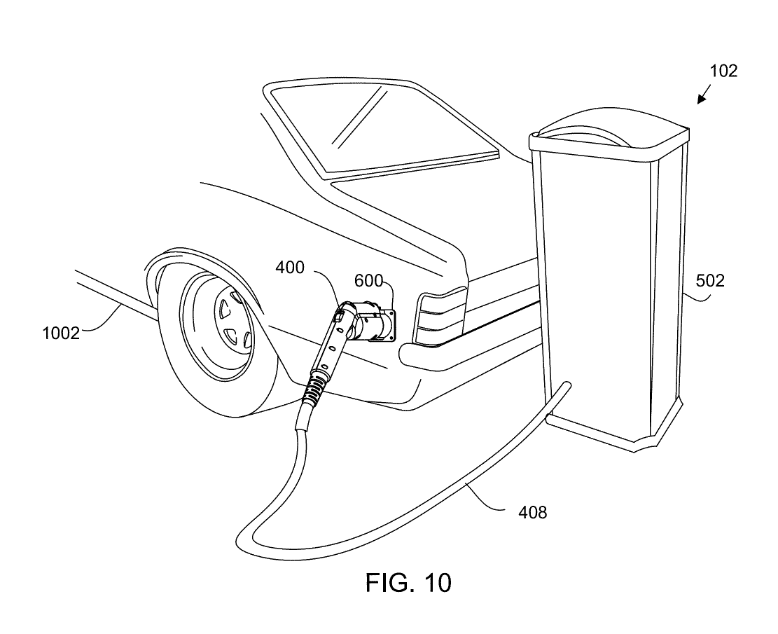

FIG. 10 is a perspective view of a vehicle 1002 plugged into a fuel distribution station 102. The fuel distribution station 102 is shown including a station housing 502, a power cable 408, and an outlet plug 400. The power cable 408 extends from the station housing 502 and includes an outlet plug 400. The outlet plug 400 is coupled to a vehicle inlet 600.

### Subscription Based Refueling Services

The systems, methods and apparatuses discussed above enable vehicle-based subscription refueling services. For example, because a specific vehicle can be securely identified, subscriptions corresponding to the vehicle for unlimited refueling within a specific time period may be sold. This is because a maximum service and/or refueling usage for the vehicle can be calculated. This is similar to how subscription communication services are often tied to a specific device or phone.

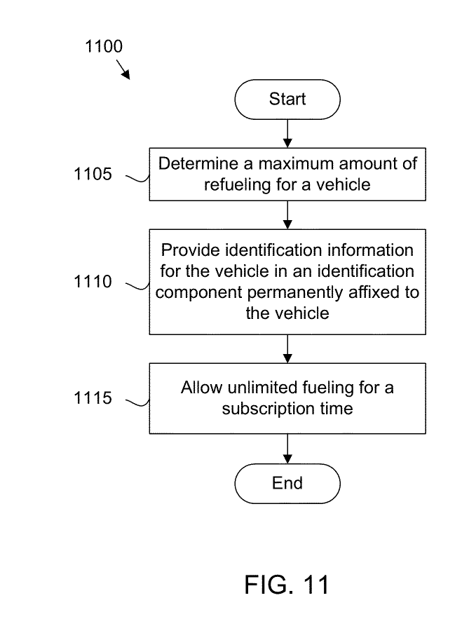

FIG. 11 is a schematic block diagram illustrating a method 1100 for providing a refueling subscription.

The method begins and a maximum amount for refueling a vehicle is determined 1105. For example, a maximum amount of fuel that a vehicle can consume in a month can be calculated based on the efficiency of the vehicle, how long it takes to use a given amount of fuel or energy, and/or how long it takes to refuel a vehicle.

An example of calculating a maximum amount of fuel usage for an electric vehicle will now be discussed. Specifically, assume that a specific electric vehicle is capable of 11 kilowatt hours (KWH) of energy storage, has a 3 kilowatt (KW) charge rate, and has a 12 KWH/hour usage rate. If this vehicle has a minimum interval of four hours between charges, the maximum percentage of time that the vehicle could be charged is:

(11 KWH reserve/3 KW rate of charge)/(11 KWH/12 KW rate of discharge+11 KWH/3 KW rate of charge+4)=(3.6667)/(8.58333)=43%

So the vehicle, at a maximum, could be charged during 43% of a subscription period. For a one month period, the maximum hours would be:

43%*24*30=310 hours

Thus, a provider can know that absolute cost will be 310 hours of recharging, as long as the recharging is restricted to the specific vehicle. Comparatively, if authorization information could be shared across multiple vehicles and/or by multiple people, that maximum amount of charging is much higher and may not even be possible to determine. This is partly because there are no necessary gaps between refueling, as there would be if only one car is allowed to be refueled under a subscription. As an example, assuming a zero interval between charges and no requirement for discharge, because the information may be shared, we see potential non-overlapping usage of (11 KWH/3 KW)/(0 rate of discharge+11 KWH/3 KWH+0 interval delay)=100%, assuming the identification information can only be used with one device at a time. If overlapping is possible (i.e. multiple vehicles recharging at same time) this could be even higher. Thus, securely limiting refueling or recharging to a specific vehicle allows for a significantly reduced and/or actually calculable maximum.

According to one embodiment, determining 1105 the maximum amount can be done in the manner discussed above, or may be looked up in a database of fuel usage information for various cars. For example, a data profile for a vehicle type may be stored and accessed to determine 1105 the maximum amount that a vehicle can be refueled.

The method 1100 continues and identification information is provided 1110 for the vehicle. The identification information may be provided 1110 by programming an already mounted identification component 304, swapping an identification component 304, and/or mounting a new identification component 304. According to one embodiment, a new subscriber will need an RFID tag 702 or other identification component 304 mounted as illustrated in FIGS. 8 and 9. As discussed above, the identification information may be securely stored within an identification component 304 which cannot be used to fuel other vehicles.

The method 1100 also includes allowing 1115 unlimited fueling at a fuel distribution station for the subscription time period. For example, a user may be able to refuel a vehicle without paying for each refuel and/or without any tracking of the refuel. For example, the individual will not need to pay any extra money for refueling as the vehicle has a corresponding unlimited subscription. In one embodiment, the recharging of the vehicle will be allowed 1115 in response to the fuel distribution station 102 receiving the identification information. For example, the fueling of the vehicle may be allowed 1115 based on identification information corresponding to a current subscription listed in an authorization list maintained by the fuel distribution station.

In addition, the method 1100 may also include updating an authorization list at the fuel distribution station. This may include deleting information corresponding to accounts or subscriptions that have expired as well as adding information corresponding to new accounts or subscriptions. In one embodiment, the authorization list may only be updated on a period greater than or equal to about one hour. In another embodiment, the authorization list may only be updated on a period greater than or equal to about one day. In another embodiment, the authorization list may only be updated on a period greater than or equal to about one week.

### EXAMPLES

The following examples pertain to further embodiments.

Example 1 is a vehicle charging station comprising a power distribution interface, a receiver component, and an authorization component. The power distribution interface is configured to electrically couple with and provide electrical power to a power receiving interface of a vehicle. The power distribution interface includes a power cable extending from the vehicle charging station. The power cable includes an outlet plug. The receiver component is configured to receive identification information from an identification component of the vehicle. The identification information uniquely identifies the vehicle. The receiver component is configured to communicate with the identification component when the power receiving interface is electrically coupled to the power distribution interface. The authorization component is configured to allow flow of electrical power to the vehicle in response to authorization based on the received identification information.

In Example 2, the outlet plug of Example 1 can optionally comply with a vehicle recharging standard.

In Example 3, the receiver component any of Examples 1-2 can optionally include a tag reader configured to receive the identification information over a wired connection.

In Example 4, the wired connection of Example 3 can optionally include at least a portion of a conductor corresponding to a vehicle recharging standard.

In Example 5, the wired connection any of Examples 3-4 can optionally include a wired connection over at least a portion of a proximity line.

In Example 6, the vehicle charging station of any of Examples 1-5 can optionally include a power distribution interface that complies with a first vehicle recharging standard and a power receiving interface that complies with a second vehicle recharging standard. The wired connection can optionally include an electrical connection between the power distribution interface and a the power receiving interface via an adapter configured to couple between the power distribution interface and the power receiving interface.

In Example 7, the vehicle charging station of any of Examples 1-6 can optionally include a receiver component that includes an RFID tag reader. The receiver component is configured to receive the identification information from an identification component that includes an RFID tag.

In Example 8, the vehicle charging station of any of Examples 1-7 can optionally include a receiver component that receives the identification information in response to providing a valid passcode.

In Example 9, the vehicle charging station of any of Examples 1-8 can optionally include a receiver component that is positioned to align with the identification component of the vehicle when the power distribution interface is electrically coupled to the power receiving interface. The alignment of the receiver component with the identification component allows electromagnetic communication between the identification component and the receiver component.

In Example 10, the vehicle charging station of any of Examples 1-9 can optionally include an indicator light for indicating one or more of a charge status and an authorization status for the vehicle.

Example 11 is a vehicle fueling interface that includes a fuel receiving interface and an identification component. The fuel receiving interface is integrated with a body of a vehicle for coupling with and receiving fuel from a distribution interface of a fuel distribution station. The identification component on the fuel receiving interface is configured to provide identification information to the fuel distribution station, the identification information uniquely identifying a vehicle. The identification component is permanently affixed to the vehicle and the identification component is not removable from the vehicle without damaging the identification component.

In Example 12, the vehicle charging station of Example 11 can optionally include an identification component that self-destructs in response to removal from the vehicle.

In Example 13, the vehicle charging station of Example 12 can optionally include an identification component that self-destructs by mechanically destroying the identification component.

In Example 14, the vehicle charging station of any of Examples 12-13 can optionally include an identification component that self-destructs by electronically destroying the identification information.

In Example 15, the vehicle charging station of any of Examples 11-14 can optionally include a fuel receiving interface that includes a power receiving interface and a distribution interface that includes a power distribution interface. Receiving fuel includes receiving electrical energy from the power distribution interface.

In Example 16, the vehicle charging station of Example 15 can optionally include a power receiving interface that includes a vehicle inlet. The vehicle inlet includes a conductor configured to physically mate with an outlet plug of the power distribution interface.

In Example 17, the vehicle charging station of Example 16 can optionally include an identification component that is mounted on the vehicle inlet.

In Example 18, the vehicle charging station of Example 17 can optionally include an identification component that includes an RFID tag.

In Example 19, the vehicle charging station of any of Examples 17-18 can optionally include an identification component that includes a tag configured to provide the identification information over a wired connection.

In Example 20, the vehicle charging station of Example 19 can optionally include a wired connection that includes the conductor configured to physically mate with the outlet plug. The tag is configured to provide the identification information to the receiver component via the conductor.

In Example 21, the vehicle charging station of any of Examples 16-20 can optionally include a vehicle inlet that complies with a recharging standard comprising one or more of an SAE J1772 standard, a CHadeMO standard, an SAE Combo standard, and a Tesla standard.

In Example 22, the vehicle charging station of any of Examples 16-21 can optionally include a vehicle inlet that is located on a body of the vehicle.

In Example 23, the vehicle charging station of any of Examples 16-22 can optionally include an outlet plug that is on a power cable extending from the fuel distribution station. The outlet plug is configured to mate with the vehicle inlet.

In Example 24, the vehicle charging station of any of Examples 16-23 can optionally include an identification component that is configured to provide the identification information in response to receiving a valid passcode.

In Example 25, the vehicle charging station of any of Examples 16-24 can optionally include an identification component that is mounted on the vehicle inlet and is not removable from the vehicle inlet without damaging the identification component.

In Example 26, the vehicle charging station of Example 25 can optionally include an identification component that self-destructs in response to removal from the vehicle inlet.

In Example 27, the vehicle charging station of any of Examples 15-26 can optionally include an identification component that is positioned to align with a receiver component of the fuel distribution station when the power receiving interface is electrically coupled to the power distribution interface. The alignment of the identification component with the receiver component allows electrical communication between the identification component and the receiver component.

In Example 28, the vehicle charging station of any of Examples 15-27 can optionally include a power receiving interface that includes a first wireless power coupling configured to wirelessly receive power from a second wireless power coupling of the power distribution interface.

Example 29 is a system that includes a vehicle charging station that includes a power distribution interface and a receiver component. The power distribution interface is configured to electrically couple with and provide electrical power to a vehicle. The power distribution interface includes a power cable extending from the vehicle charging station. The power cable includes an outlet plug. The receiver component is located in or on the power cable and is configured to receive identification information uniquely identifying the vehicle. The system also includes a vehicle charging interface that includes a power receiving interface and an identification component. The power receiving interface is integrated with a body of the vehicle for coupling with and receiving electrical power from the power distribution interface to charge the vehicle. The identification component is located on the fuel receiving interface for providing identification information to the fuel distribution station. The identification information uniquely identifies the vehicle. The identification component is permanently affixed to the vehicle and the identification component is not removable from the vehicle without damaging the identification component. The identification component and the receiver component are communicatively aligned when the power distribution interface and fuel receiving interface are coupled.

In Example 30, the system of Example 29 can optionally include a receiver component that receives the identification information in response to coupling of the distribution interface and the fuel receiving interface.

In Example 31, the system of any of Examples 29-30 can optionally include a power receiving interface that electrically charges a battery of the vehicle.

In Example 32, the system of any of Examples 29-31 can optionally include a distribution interface that includes an outlet plug attached to the fuel distribution station via a power cable and the fuel receiving interface includes a vehicle inlet on the body of the vehicle.

In Example 33, the system of any of Examples 29-32 can optionally include an outlet plug and power cable that comply with an SAE J1772 standard.

In Example 34, the system of any of Examples 29-33 can optionally include a vehicle inlet that complies with an SAE J1772 standard.

In Example 35, the system of any of Examples 29-34 can optionally include an outlet plug that includes an indicator light. The indicator light indicates one or more of an authorization status of the vehicle and a charging status of the vehicle.

In Example 36, the system of any of Examples 29-35 can optionally include a receiver component that includes an RFID reader.

In Example 37, the system of any of Examples 29-36 can optionally include an RFID reader that includes an antenna located to align with an RFID tag.

In Example 38, the system of any of Examples 29-37 can optionally include an RFID reader that is at least partially embedded in an outlet plug.

In Example 39, the system of any of Examples 29-38 can optionally include a distribution interface that includes a first wireless power coupling and a fuel receiving interface that includes a second wireless power coupling. The first and second wireless power couplings wirelessly electrically couple to charge the vehicle.

In Example 40, the system of any of Examples 29-39 can optionally include a flow component for selectively allowing flow of electricity between the vehicle charging station and the vehicle charging interface in response to receiving a signal indicating authorization for the vehicle.

In Example 41, the system of any of Examples 29-40 can optionally include an authentication component for authorizing electrical power flow to the vehicle based on the identification information.

Example 42 is a system that includes a vehicle charging station and a vehicle charging interface. The vehicle charging station includes a power distribution interface and a receiver component that is configured to receive identification information uniquely identifying a vehicle. The vehicle charging interface includes a power receiving interface and an identification component. The power receiving interface is configured to electrically couple with and receive electrical power from the power distribution interface to charge the vehicle. The identification component is configured to provide the identification information to the vehicle charging station and is permanently affixed to the vehicle. The identification component and the receiver component are communicatively aligned when the power distribution interface and power receiving interface are electrically coupled.

Example 43 is a method. The method includes determining a maximum amount of refueling for a vehicle in a subscription time period, the maximum amount based on the vehicle type. The method includes providing identification information for the vehicle in an identification component permanently affixed to the vehicle. The method includes allowing unlimited fueling at a fuel distribution station for the subscription time period in response to the fuel distribution station receiving the identification information.

In Example 44, the method of Example 43 can optionally include affixing the identification component to the vehicle, the identification component comprising an RF ID tag or other tag.

In Example 45, the method of any of Examples 43-44 can optionally include allowing fueling based on the identification information corresponding to a current subscription listed in an authorization list maintained by the fuel distribution station.

In Example 46, the method of any of Examples 43-45 can optionally include updating on an update period an authorization list at the fuel distribution station.

In Example 47, the method of any of Examples 43-46 can optionally include updating on an update period that is greater than or equal to about an hour.

In Example 48, the method of any of Examples 43-47 can optionally include updating on an update period that is greater than or equal to about a day.

Various aspects of certain embodiments may be implemented using hardware, software, firmware, or a combination thereof. As used herein, a software component may include any type of computer instruction or computer executable code located within or on a non-transitory computer-readable storage medium. A software component may, for instance, comprise one or more physical or logical blocks of computer instructions, which may be organized as a routine, program, object, component, data structure, etc., that performs one or more tasks or implements particular abstract data types.

In certain embodiments, a particular software component may comprise disparate instructions stored in different locations of a computer-readable storage medium, which together implement the described functionality of the component. Indeed, a component may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing the processes, apparatuses, and system described herein. Accordingly, the present embodiments are to be considered illustrative and not restrictive, and the invention is not to be limited to the details given herein, but may be modified within the scope and equivalents of the appended claims.

As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus.

It will be obvious to those having skill in the art that many changes may be made to the details of the above-described embodiments without departing from the underlying principles of the invention. The scope of the present invention should, therefore, be determined only by the following claims.

1. A vehicle charging station comprising:
a power distribution interface for electrically coupling with and providing electrical power to a power receiving interface of a vehicle, the power distribution interface comprising a power cable extending from the vehicle charging station, the power cable comprising an outlet plug;
a receiver component for receiving identification information from an identification component of the vehicle, the identification information uniquely identifying the vehicle, wherein the receiver component is configured to communicate with the identification component when the power receiving interface is electrically coupled to the power distribution interface; and
an authorization component configured to allow flow of electrical power to the vehicle in response to authorization based on the received identification information.

2. The vehicle charging station of claim 1, wherein the outlet plug complies with a vehicle recharging standard.

3. The vehicle charging station of claim 1, wherein the receiver component comprises a tag reader configured to receive the identification information over a wired connection.

4. The vehicle charging station of claim 3, wherein the wired connection comprises a wired connection including at least a portion of a conductor corresponding to a vehicle recharging standard.

5. The vehicle charging station of claim 3, wherein the wired connection comprises a wired connection over at least a portion of a proximity line.

6. The vehicle charging station of claim 3, wherein the power distribution interface complies with a first vehicle recharging standard and the power receiving interface complies with a second vehicle recharging standard, wherein the wired connection comprises an electrical connection between the power distribution interface and a the power receiving interface via an adapter configured to couple between the power distribution interface and the power receiving interface.

7. The vehicle charging station of claim 1, wherein the receiver component comprises a radio frequency identification (RFID) tag reader and wherein the receiver component receives the identification information from the identification component comprising an RFID tag.

8. The vehicle charging station of claim 1, wherein the receiver component receives the identification information in response to providing a valid passcode.

9. The vehicle charging station of claim 1, wherein the receiver component is positioned to align with the identification component of the vehicle when the power distribution interface is electrically coupled to the power receiving interface, wherein alignment of the receiver component with the identification component allows electromagnetic communication between the identification component and the receiver component.

10. The vehicle charging station of claim 1, further comprising an indicator light for indicating one or more of a charge status and an authorization status for the vehicle.

11. A vehicle fueling interface comprising:
a fuel receiving interface integrated with a body of a vehicle for coupling with and receiving fuel from a distribution interface of a fuel distribution station; and
an identification component on the fuel receiving interface for providing identification information to the fuel distribution station, the identification information uniquely identifying a vehicle, wherein the identification component is permanently affixed to the vehicle and wherein the identification component is not removable from the vehicle without damaging the identification component.

12. The vehicle fueling interface of claim 11, wherein the identification component self destructs in response to removal from the vehicle.

13. The vehicle fueling interface of claim 12, wherein the identification component self destructing comprises mechanically destroying the identification component.

14. The vehicle fueling interface of claim 12, wherein the identification component self destructing comprises electronically destroying the identification information.

15. The vehicle fueling interface of claim 11, wherein the fuel receiving interface comprises a power receiving interface and the distribution interface comprises a power distribution interface, and wherein receiving fuel comprises receiving electrical energy from the power distribution interface.

16. The vehicle fueling interface of claim 15, wherein the power receiving interface comprises a vehicle inlet, the vehicle inlet comprising a conductor configured to physically mate with an outlet plug of the power distribution interface.

17. The vehicle fueling interface of claim 16, wherein the identification component is mounted on the vehicle inlet.

18. The vehicle fueling interface of claim 17, wherein the identification component comprises a radio frequency identification (RFID) tag.

19. The vehicle fueling interface of claim 17, wherein the identification component comprises a tag configured to provide the identification information over a wired connection.

20. The vehicle fueling interface of claim 19, wherein the wired connection comprises the conductor configured to physically mate with the outlet plug, wherein the tag is configured to provide the identification information to the receiver component via the conductor.

21. The vehicle fueling interface of claim 16, wherein the vehicle inlet complies with a vehicle recharging standard comprising one or more of a society of automotive engineers (SAE) J1772 standard, a CHadeMO standard, an SAE Combo standard, and a Tesla standard.

22. The vehicle fueling interface of claim 16, wherein the vehicle inlet is located on a body of the vehicle.

23. The vehicle fueling interface of claim 16, wherein the outlet plug is on a power cable extending from the fuel distribution station, the outlet plug configured to mate with the vehicle inlet.

24. The vehicle fueling interface of claim 16, wherein the identification component is configured to provide the identification information in response to receiving a valid passcode.

25. The vehicle fueling interface of claim 16, wherein the identification component is mounted on the vehicle inlet and is not removable from the vehicle inlet without damaging the identification component.

26. The vehicle fueling interface of claim 25, wherein the identification component self-destructs in response to removal from the vehicle inlet.

27. The vehicle fueling interface of claim 15, wherein the identification component is positioned to align with a receiver component of the fuel distribution station when the power receiving interface is electrically coupled to the power distribution interface, wherein alignment of the identification component with the receiver component allows electrical communication between the identification component and the receiver component.

28. The vehicle fueling interface of claim 15, wherein the power receiving interface comprises a first wireless power coupling configured to wirelessly receive power from a second wireless power coupling of the power distribution interface.
